(19) United States
(12) Patent Application Publication
(10) Pub. No.: US 2006/0057370 A1
(43) Pub. Date: Mar. 16, 2006

(54) Labeling adhesive and use thereof

(76) Inventors: Thierry Pasquier, Miserieus (FR); Samantha J. Smith, Windsor (GB)

Correspondence Address: NATIONAL STARCH AND CHEMICAL COMPANY, P.O. BOX 6500, BRIDGEWATER, NJ, 08807-3300, US

(21) Appl. No.: 10/940,520

(22) Filed: Sep. 14, 2004

(51) Int. Cl. B32B 7/12

(52) U.S. Cl. 428/350; 428/355 EN

(57) ABSTRACT

Labels, labeled containers and method of labeling a container wherein the label comprises a pre-applied adhesive that is reactivated with moistenable.

### FIELD OF THE INVENTION

The invention relates to the field of adhesives. More specifically the invention relates to pre-applied or pre-glued labels and the use thereof in labeling applications.

### BACKGROUND OF THE INVENTION

Adhesives that may be applied to a substrate and then later reactivated (e.g., by pressure, moisture, and/or heat) to bond the substrate to a second chosen substrate provide a number of advantages. One major advantage is that the end user of the adhesive does not need to devote time and resources to adhesive related issues such as selection, processing, trouble shooting, application, clean-up, inventory and the like.

Water remoistenable adhesives are dry adhesive compositions which, when moistened with water, develop an adhesive tackiness. Water remoistenable pre-applied adhesives are known and practiced in the art. Such adhesives are conventionally used on postage stamps, wallpaper, tapes, labels, envelope flaps and the like. Water remoistenable adhesive compositions are described, for example, in U.S. Pat. Nos. 4,678,824, 4,719,264, 4,910,048 and 5,296,535.

While, as noted above, water remoistenable pre-applied adhesive labels are known, use of such labels in high speed labeling applications, in particular in the labeling of glass and plastic bottles with a paper, plastic, metalized or other type label, has not been possible due to lengthy drying time, long set or cure times, and/or lack of sufficient wet tack. A need exists for reactivatable adhesives and methods of preparing labels having applied to the surface thereof a pre-applied reactivatable adhesive that are useful in high speed labeling applications. The current invention addresses this need.

### SUMMARY OF THE INVENTION

The current invention provides articles comprising a water remoistenable adhesive which, having been applied to a substrate and allowed to dry, is capable, upon reactivation with moisture, of bonding the substrate to a second substrate.

One aspect of the invention provides adhesives that may be pre-applied to a substrate, in particular a paper or plastic substrate, and allowed to dry. When ready to use, i.e., when ready to bond the substrate having the dried adhesive applied thereto to a second substrate, the adhesive is reactivated upon exposure to moisture. The reactivatable adhesive of the invention is advantageously used in the preparation of articles, in particular labels.

Another aspect of the invention is directed to a process for bonding at least a first substrate to at least a second substrate, wherein at least a portion of at least one of said substrates has applied thereon an adhesive which upon exposure to moisture is capable of bonding the substrate to a second substrate. In the practice of the invention an adhesive component is applied to a substrate and allowed to dry. In a preferred embodiment the adhesive is applied to the substrate in an irregular or a discontinuous manner, e.g., striped or otherwise patterned. Even more preferred, the substrate is a labeling substrate. The process comprises exposing the applied dry adhesive present on the substrate to moisture for a time sufficient to moisten the adhesive, bringing the substrate comprising the remoistened adhesive in contact with another substrate, and allowing the adhesive to dry thereby bonding the substrate to the other substrate. In a preferred embodiment the first substrate is a paper or plastic label and the second substrate is a glass or plastic container such as a jar or a bottle.

A further aspect of the invention is directed to a labeled container, such as a bottle or jar, wherein the label is attached to the container using a reactivated adhesive.

Still another aspect of the invention is directed to articles of manufacture comprising a water reactivatable adhesive that upon exposure to moisture is capable of bonding a paper or plastic substrate to a second substrate. In the practice of the invention an adhesive component is applied to a paper or plastic article of manufacture and allowed to dry. Preferred articles of manufacture are labels. Labels having a front side and a back or reverse side will typically carrying information printing and/or design on the fronts side and the reverse side will have applied thereon a remoistenable adhesive. Articles comprising the dried adhesive, upon rewetting of the adhesive, are capable of being bonded to a second substrate, in particular a second glass or plastic substrate.

Yet another aspect of the invention is directed to a method of labeling a container whereby one substrate (a label) is bonded to a second substrate (a container), wherein the label has an adhesive pre-applied to at least one surface thereof and allowed to dry. The method comprises exposing the dry adhesive present on the label to moisture for a time sufficient to remoisten the adhesive, bringing the remoistened adhesive in contact with the container to which it is to be bonded and, optionally, applying pressure to effect said bonding together.

### DETAILED DESCRIPTION OF THE INVENTION

The invention provides an adhesive, a method for bonding a first substrate to a second substrate, articles manufactured using the adhesive, in particular pre-applied adhesive labels and labeled bottles and jars.

The invention provides the labeling industry with new kinds of labeling adhesives useful for applying labels onto glass or plastic containers. The adhesive has strong tack to hold the label on the glass or plastic substrate and satisfactorily secures the label (plastic or paper or the like) to the glass within a short time. Moreover, the adhesive of the invention may be applied using conventional high-speed labelers such as pallet transfer rotary labelers of the type manufactured by Krones, Ltd. or Trine Labeling Systems.

The invention comprises coating an adhesive in liquid form on the reverse or back side of paper or plastic (e.g. OPP, PET, cellulose-based films) labels, and allowing the adhesive to dry. Pre-application of the adhesive on the label is made up-front in the labeling process, at a converter (e.g. paper manufacturer or printer or coater) before or after the printing, metalising (if applicable) process, the adhesive being applied as a striped or otherwise patterned coating (i.e., an irregular or discontinuous coating) or as full coating (i.e., a continuous coating). The adhesive forms a coating or film (continuous or discontinuous) upon drying that is tack-free. Pre-applied or pre-glued labels are delivered to the end-user who will use them to label containers (e.g., bottles) on its existing machine by water re-activation. Upon subsequent application of moisture, a thin adhesive layer is formed having the required tack, open time and setting speed for bottle labeling applications using a high speed bottle labeler. The adhesive can be reactivated by water either in the form of a mist or via a transfer mechanism (e.g., roller to pallet to predated label) using conventional labeling machines. The roller and pallet will preferably be coated in a suitable material for the transfer of water, e.g., foam/sponge/rubber/metal, to the pre-applied adhesive present on the label whereby bonding or labeling of glass and/or plastic containers occurs.

In the practice of the invention, use of water based adhesives (e.g. casein, dextrin or synthetic based adhesives) are removed from the bottling site, simplifying the labeling process, improving quality of labeling, improving productivity and line efficiency and allowing substantial savings in maintenance cost and downtime.

In conventional bottle labeling, adhesive is applied to the label, and label subsequently affixed to the bottle on the production line. While this process works reasonably well, it requires the bottle company to devote a tremendous amount of time and attention to adhesive-related issues, including adhesive selection, processing, trouble shooting and inventory. First, selection of an adhesive having the required adhesion, setting speed, and open time is a lengthy process. Then the adhesive needs to be processed in appropriate ways including transporting and applying. If anything is wrong with the processing, the bottles will not be labeled properly, the bottling line must be stopped, and the problem identified and fixed.

In accordance with the practice of the invention, the majority of quality issues on the labeling line (e.g., flagging, wrinkling, scuffing, smearing, leaching, slipping, etc.) are removed or significantly reduced. In addition, down time linked to liquid usage such as cleaning due to splashing and throwing, and to the removal of dry liquid adhesive on coating systems and machine parts, is significantly reduced.

The invention provides a method of obtaining a consistent coating weight of adhesive on labels, thereby ensuring better and sustainable quality of labeling (due to pre-applied coating of adhesive of specific coaters). This leads to reduced consumption of adhesive per bottle and savings for the bottling company. Use of the invention improves line efficiency and simplifies the process for the bottler, having only one type of material (labels) to order instead two (labels+glue), and storage and use of water based labeling adhesive that require controlled temperature to avoid freeze and hot conditions, and the chance that the adhesive inventory may be spoiled by microbial contamination.

The invention may be used in all sectors of packaging and labeling, including but not limited to traditional paper labeling (cut and stack labels) for the beverages industry (e.g. beer, wine, mineral water, soft drinks, fruit juices, etc), but also for the food industry (e.g. bottling of liquid milk) and non food industry (labeling of miscellaneous container such as liquid detergents, chemical and other liquid materials). Included are “no label look” plastic labeling, i.e., transparent labels, for the same markets and industries.

The adhesive is applied to a substrate and dried to harden the adhesive layer. The adhesive product can be applied to a substrate such a plastic or paper label article by a variety of methods including coating or spraying in an amount sufficient to cause, following drying and subsequent reactivation, the article to adhere to another substrate or an unrelated material such as a low density polyolefin or other conventionally employed substrates.

While the adhesive finds particular use as a labeling adhesive, other uses are clearly contemplated and are encompassed by the invention. The adhesive described herein may be used for, e.g., laminating.

As used herein a “container” means a jar, bottle, can or canister, bucket, beaker and the like. The container may be made of glass, plastic or metal. Specific examples include, but are not limited to soft drink bottles, beer bottles, wine bottles, salad dressing bottles, sauce jars, condiment jars, and the like. The container may be made of any type of material including but not limited to wood, glass, metal, plastic or poly and plastic-coated glass.

As used herein a “label” means e.g., a material having a surface to which an adhesive is applied. The label may be made of any type of material, including but not limited to paper, plastic or metalised paper and the like. Labels may be of any size or shape. While the label may be opaque, use of plastic labels wherein at least a portion is transparent is contemplated. By “transparent” means that at least a portion of the label is substantially clear, i.e., the surface of the substrate to which the label has been applied is visible through the label and adhesive.

Use of the adhesives of the invention to bond labels to glass or plastic substrates is particularly advantageous.

Plastic as used herein refers to the material used to make e.g., food and other storage containers and/or labels include polyethylene, polypropylene, polystyrene, polycarbonate, polyvinylchloride, high density polyethylene (HDPE) and polyethylene terephthalate (PET).

To attach the labels of the invention to the container to be labeled, the pre-applied adhesive is contacted with moisture in the form of water, steam, spray mist or the like. It will be appreciated that conventional labelers can be used, wherein the mechanism that previously applied glue to the surface of the label instead applies water to the pre-applied adhesive surface of the label. The label and the article are then contacted under pressure and the adhesive bond allowed to set. The amount of pressure and the time need to set the bond will depend upon the type of container, label, and the particular adhesive formulation used. Labels can be applied to bottles in accordance with the invention at rates of up to 200 bottles per hour, more typically up to about 60,000 bottles per hour.

The application involves applying a water-based adhesive to a paper substrate, drying the adhesive and then passing the substrate comprising the dried adhesive to further processing and handling steps such as cutting an/or perforation.

Adhesives contemplated for use are water-based and may be comprised of synthetic or natural ingredients. Depending of the method of application (i.e., pre-application) of the adhesive to the label, viscosity will range from about 100 to about 130,000 cps.

The application of the adhesive onto a substrate for later activation or “reactivation” is referred to herein, and in the art as a “pre-applied” adhesive. The adhesive present on the substrate may be reactivated at any time after initial application to the substrate for bonding the substrate to a second substrate.

Reactivation, as this term is used herein, refers to an adhesive that resides on at least a portion of at least one substrate to be bonded to a second substrate. That is, the adhesive has been applied to a substrate in the liquid state and allowed to dry, i.e., solidify, thereon. The adhesive present on the first substrate is thereafter reactivated or remoistened back to a liquid state, by contacting the dry adhesive with moisture (e.g., water, mist, steam, saliva or the like). The substrate is brought in contact with the second substrate and the adhesive allowed to dry or solidify, thereby bonding the two substrates together. The terms remoistenable and reactivatable are used interchangeably though out this disclosure.

In the practice of the invention, adhesive present on at least one of the two substrates to be bonded together will be reactivated with water. If adhesive components are present on both substrates to be bonded together, the adhesive components on both substrates will preferably be reactivated with water. The amount of water to be used in the reactivation process will be an amount sufficient to at least partially re-emulsify or resolubilize the adhesive such that it is in a highly softened and tacky state.

The invention encompasses water remoistenable adhesives which, having been applied to a paper substrate, are capable, upon reactivation with moisture, of bonding the paper substrate to a second substrate. Particularly preferred is the use of the reactivated pre-applied adhesive to bond one paper or plastic substrate to a second glass or plastic substrate. When dry, the substrates are held together by a strong durable bond.

Adhesives that can be used in the practice of the invention include synthetic resins, natural resins, natural rubbers, starches or dextrins. The adhesives of the invention may be in the emulsion or solution form.

In one preferred embodiment, the adhesives comprise at least one resin emulsion or solution, and may also comprise at least one filler or other additive. A preferred resin is polyvinyl acetate. Adhesives comprising a blend of two or more polyvinyl acetate emulsions are contemplated and the use of homopolymers, copolymers and mixtures thereof are encompassed.

Typically, the adhesive comprises more than about 30%, more typically from about 50% by weight to about 100%, more preferably 55% by weight to about 85% by weight of a resin component and from 0% by weight to about 50% by weight, more typically from about 0% to about 20% by weight of filler and/or other conventional additives.

Resin emulsions that may be used in the practice of the invention are emulsions and mixtures thereof. Adhesives comprising polyvinyl acetate and/or polyvinyl alcohol are preferred for use in the practice of the invention. Mixtures of two or more polyvinyl acetates and mixtures of polyvinyl acetate and other polymer emulsions comprising vinyl acetate and other monomers, including but not limited to ethylene and acrylic monomers, are encompassed. Polyvinyl acetate may be prepared using a continuous or a batch process. Polyvinyl acetate emulsion mixtures wherein the polyvinyl acetates used are prepared by one method or by both methods may be used. Such polyvinyl acetates are commercially available from National Starch and Chemical, Bridgewater, N.J.

In a preferred embodiment, the adhesive comprises from about 35% to about 50% by weight of a polyvinyl acetate emulsion, from about 35% to about 50% by weight of a polyvinyl alcohol solution and up to about 15% by weight of water. This adhesive is particularly well suited for pre-applied labeling applications. It exhibits excellent coating properties, i.e., good appearance, colorless, good layflat properties, good aging properties and a non-tacky coating that is suitable for dye cutting and stacking the labels which then need to be removable/separated one at a time. The coated product reactivates very quickly to provide high wet tack, which is required for machine transfer. Moreover, the composition exhibits good final adhesion properties and a sufficient level of ice water resistance.

The adhesive may also contain a filler or other conventional ingredients. Suitable fillers are those fillers known in the art as adhesive fillers and include polysaccharides, calcium carbonate, clay, mica, nut shell flours, silica, talc and wood flour.

Polysaccharides useful in the invention include starch, dextrin, cellulose, gums or combinations thereof. Particularly useful are the starches and dextrins including native, converted or derivatized. Such starches include those derived from any plant source including maize (corn), potato, wheat, rice, sago, tapioca, waxy maize, sorghum and high amylose starch such as high amylose corn, i.e. starch having at least 45% amylose content by weight. Starch flours may also be used. Also included are the conversion products derived from any of the former bases, such as, for example, dextrins prepared by hydrolytic action of acid and/or heat; fluidity or thin boiling starches prepared by enzyme conversion or mild acid hydrolysis; oxidized starches prepared by treatment with oxidants such as sodium hypochlorite; and derivatized or modified starches such as cationic, anionic, amphoteric, non-ionic, crosslinked and hydroxypropyl starches. Other useful polysaccharides are cellulose materials such as carboxymethylcellulose, hydroxypropyl cellulose and hydroxypropyl methylcellulose, and gums such as guar, xanthan, pectin and carrageenan may also be used in the practice of the invention. Modified starches include, but are not limited to, those modified with an alkyl succinic anhydride. Preferred are octenyl succinic anhydride (OSA) and dodecenyl succinic anhydride (DDSA) modified starches or dextrins.

The adhesive may also preferably contain a surface-active agent. Examples of surface-active agents include anionic, cationic, amphoteric, or nonionic surfactants, or mixtures thereof. Suitable anionic surfactants include, alkyl sulfonates, alkylaryl sulfonates, alkyl sulfates, sulfates of hydroxylalkanols, alkyl and alkylaryl disulfonates, sulfonated fatty acids, sulfates and phosphates of polyethoxylated alkanols and alkylphenols, and esters of sulfosuccinic acid. Suitable cationic surfactants include, alkyl quaternary ammonium salts, and alkyl quaternary phosphonium salts. Suitable non-ionic surfactants include the addition products of 5 to 50 moles of ethylene oxide adducted to straight-chain and branched-chain alkanols having 6 to 22 carbon atoms, alkylphenols, higher fatty acids, higher fatty acid amines, primary or secondary higher alkyl amines, and block copolymers of propylene oxide with ethylene oxide, and mixtures thereof. Suitable amphoteric surfactants include disodium lauramino propionate. Surfactants useful in the practice of the invention include surfactants modified with, e.g., alkyl succinic anhydrides, such as OSA. When used, the surface active agent will typically be added in amounts up to about 20% by weight, based on the adhesive composition as a whole. More usually from amounts of from about 0.05 to about 20% by weight, and preferably at from 0.1 to 2% by weight.

Other additives typical of adhesive compositions may be added to the adhesive composition of the invention. Said additives include, but are not limited to, humectants, flavorants, crosslinkers, plasticizers, acids, waxes, synthetic resins, tackifiers, defoamers, preservatives, bases such as sodium hydroxide, dyes, pigments, UV indicators, and other additives commonly used in the art.

Examples of humectants include those conventionally used in aqueous adhesives such as sugars (sucrose, fructose), urea, glycols, glycerine and salts such as sodium chloride, sodium nitrate and calcium chloride. The humectant will generally be used in amounts of from about 1.0 to about 20.0%.

Typical preservatives for use herein include those conventionally used in aqueous adhesives such as benzoates, amides and fluorides such as sodium fluoride. Also included are the hydroxybenzoic acid esters such as p-hydroxybenzoic acid methyl ester or p-hydroxybenzoic butyl ester. Commercially available preservatives which may be used in the practice of the invention include KATHON LXE sold by Rohm & Haas Company and Nipacide OBS sold by Clariant. The preservative will generally be included in amounts of from 0.05% to about 0.2% by weight.

In a second embodiment, the adhesive comprises a starch component and a gelatin/animal glue component. The starch component may desirably comprise at least two substantially different types of starch, such as both a high amylose containing starch and a starch having a high amylopectin content. Adhesives of the invention also, preferably, will contain a liquifier, a curing agent and/or a humectant or plasticizer, and may further, if desired, contain a blowing agent, a viscosity modifier, an anti-foamer and/or a preservative. Water is used as the adhesive carrier. One preferred adhesive comprises a modified waxy starch, a hydrolyzed potato starch, gelatin, zinc carbonate, urea, and dicyandiamide.

The adhesive composition may, if desired, be foamed by the addition of energy, by means known in the art such as, but not limited to, by mechanical and/or chemical means. Air or other gases are added to the foamable adhesive composition along with the addition of said energy to produce a stable, consistent foamed adhesive. Preferably air is used to produce the foamed adhesive. The adhesive foam may be produced by mechanical means such as mechanical stirring or agitation, introduction of gases or by chemical means.

The amount of air dispersed in the adhesive can vary depending on the particular formulation, but will generally be from about 5% (by volume) up to about 75% (by volume) or greater, more typically from about 10 up to about 50% (by volume), even more typically from about 20 up to about 35% (by volume).

The adhesive may be applied to the substrate by any method known in the art. The adhesive product can be applied to a substrate by a variety of methods including coating or spraying in an amount sufficient to cause the article to adhere to another substrate upon reactivation. The adhesive formulations of the invention may be pre-applied in a continuous or discontinuous, e.g., as evenly spaced beads, separated striped pattern or other desired pattern depending on surface area and coating weight desired. Particular patterns may be used to optimize substrate/adhesive contact. Depending on the adhesive, the bead size, thickness, distance apart and pattern will vary.

The adhesive may be pre-applied to the substrate by any method known in the art, and include, without limitation roll coating, painting, dry-brushing, dip coating spraying, slot-coating, swirl spraying, printing (e.g., ink jet printing), flexographic, extrusion, atomized spraying, gravure (pattern wheel transfer), electrostatic, vapor deposition, fiberization and/or screen printing. While the method of pre-application of the adhesive to the substrate is not critical to the practice of the invention, it has been discovered that labels having adhesive pre-applied as a discontinuous pattern, such as in lines or stripes of adhesive, is particularly preferred in the practice of the invention and provide optimum reactivation performance. Striped patterns contemplated for use may comprise uniform stripes or stripes of different widths. The stripes may be straight or wavy. The stripes themselves may also be broken up, i.e., each strip is composed of a series of spaced apart fragments. In addition, the stripes may be equidistant apart or may be disposed at different distances apart from one another.

The adhesive is applied to a substrate while in its liquid state and allowed to dry to harden the adhesive layer. The adhesive can be allowed to air dry or can be dried by other conventional means, such as with the use of ovens.

The reactivation efficiency, i.e., the ability of the adhesive to become wetted or moistened in a short period of time will depend on the water solubility of the components in the adhesive formulation. Reactivation time depends on receptivity of the adhesive, which depends on the coating weight or thickness of the adhesive and the amount of water applied.

In the practice of the invention, exposure to moisture is typically for periods of less than about 5 seconds. Pressure is typically applied for periods of less than about 30 seconds. Typically water is used to wet the surfaces. The water may be in the form of a mist, spray, saturated material (e.g., wet sponge) or steam.

The adhesive formulations of the invention may be used to bond one substrate (a label) to a second similar or different substrate (container such as a bottle or jar). Preferred are paper and plastic labels. Use of the term “paper” is meant to include light paper, paperboard, cardboard, corrugated paperboard, polyolefin coated paper and the like. The surface of the paper to which the adhesive is applied may be printed or be unprinted.

The adhesive of the invention may be applied to various articles of manufacture and can advantageously be used to bond substrates together. The invention provides a process of bonding a first substrate to a second substrate wherein said first substrate has preapplied to at least a portion of a surface of said first substrate a first adhesive composition and wherein said second substrate has preapplied to at least a portion of a surface of said second substrate a second adhesive composition, said method comprising contacting said first adhesive present on said first substrate to said second adhesive present on said second substrate thereby bonding said first substrate to the second substrate. In one embodiment the preapplied adhesive on at least one of said first or second substrate is activated by exposure to moisture prior to contacting said first adhesive to said second adhesive.

It will be appreciated that in place of an external source of moisture, the adhesive may be reactivated by placing the label comprising the reactivatable label on the surface of a bottle having present on the surface thereof condensation caused by chilling of the filled liquid material.

The invention provides a water remoistenable adhesive which, having been applied to a paper substrate and allowed to dry, is capable, upon reactivation with moisture, of bonding the paper substrate to a second substrate. Adhesives useful in the practice of the invention will generally exhibit greater than 50% fiber tear, more typically greater than 75% fiber tear, even more preferred for use are adhesives exhibiting complete substrate failure (100% fiber tear).

The following examples are for purpose of illustration and not intended to limit the scope of the invention in any manner.

### EXAMPLES

### Example 1

An adhesive comprising 57 parts polyvinylacetate homopolymer, 8.5 parts polyvinylalcohol, 3.5 parts humectant, 0.1 parts preservative and 0.1 parts surfactant and 30.8 parts water was prepared. The adhesive had a viscosity of 1,200 centipoise, a solids content of 44%, and pH of 5.5. The adhesive was used to coat the surface of a 3 mil paper substrate and allowed to air dry completely. The substrate that had been pre-applied with adhesive was rewetted and bonds prepared immediately following rewetting by bringing wetted adhesive present on the substrate in contact with a second substrate. The bonded substrates were allowed to set for one hour at room temperature. Bond strength and % fiber test was tested. 100% fiber tear was observed.

### Example 2

52% water, 0.2% defoamer, 0.9% zinc carbonate and 12% urea were mixed (e.g. in a vessel with a rotating agitator) until homogeneous, after which 7.8% Collys Br and 23.5% Dexylose I 231 were added. The mixture was then heated to 72° C. and held at this temperature for 20 mins. The mixture was then cooled to 65° C. and 0.6% ammonium acetate added. 3% Bone glue was then added between 60 and 65° C. and the final mixture cooled to room temperature. The adhesive samples were coated onto a transparent plastic label and allowed to dry. The adhesive that had been pre-applied to the label was rewetted and bonds prepared immediately following rewetting by bringing the wetted adhesive present on the substrate in contact with the surface of a glass jar. The bonded substrates were allowed to set for one hour at room temperature. The adhesive exhibited good wet tack. Dried adhesive was substantially clear, with the glass substrate visible through the dried adhesive.

### Example 3

49.8 parts water and 10 parts polyvinyl alcohol were mixed (e.g. in a vessel with a rotating agitator). The mixture was then heated to 90° C. and held at this temperature for 1 hour. The mixture was then cooled to room temperature and then 40 parts polyvinylacetate homopolymer, 0.1 parts preservative and 0.1 parts surfactant added and mixed until homogeneous.

If desired, the polyvinyl alcohol cookup can be produced seperately and added as an intermediate.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A label comprising a water remoistenable adhesive, wherein the adhesive is capable, upon reactivation with moisture, of bonding the label to a second substrate, wherein said adhesive is applied to the label in a discontinuous manner.

2. A label comprising a water remoistenable adhesive, wherein the adhesive is capable, upon reactivation with moisture, of bonding the label to a second substrate, wherein said adhesive comprises from about 35% to about 50% by weight of a polyvinyl acetate emulsion and from about 35% to abut 50% by weight of a polyvinyl alcohol solution.

3. The label of claim 2 where the adhesive is applied in a continuous manner

4. The label of claim 2 where the adhesive is applied in a discontinuous manner.

5. The label of claim 1 or 3 wherein the adhesive is applied by gravure.

6. The label of claim 1 or 2 wherein the adhesive has a viscosity of from about 100 to about 13,000 cps.

7. The label of claim 1or 2 which comprises a plastic substrate.

8. The label of claim 7 wherein the plastic substrate is transparent.

9. The label of claim 1 wherein the adhesive comprises from about 35% to about 50% by weight of a polyvinyl acetate emulsion and from about 35% to abut 50% by weight of a polyvinyl alcohol solution.

10. A method of bonding a first substrate to a second substrate wherein said first and/or second substrate has pre-applied to at least a portion of a surface of said first and/or second substrate a water remoistenable adhesive, said method comprising contacting the adhesive present on said first and/or second substrate with moisture to reactivate the adhesive and thereafter bringing the surfaces of said first substrate and second substrates together whereby the first substrate is bonded to the second substrate, said adhesive comprising from bout 35% to about 50% by weight of a polyvinyl acetate emulsion and from about 35% to abut 50% by weight of a polyvinyl alcohol solution.

11. The label of claim 10 where the adhesive is pre-applied to the substrate in a continuous manner

12. The label of claim 10 where the adhesive is pre-applied to the substrate in a discontinuous manner.

13. A process for labeling a container comprising moistening the adhesive present of the adhesive of claim 1 or 2 with water and contacting the remoistened adhesive a container.

14. The process of claim 13 wherein from about 2000 to about 100,000 containers are labeled per hour.

15. The process of claim 13 wherein the container is a bottle.

16. A labeled container prepared by the process of claim 13.

17. The labeled container of claim 16 which is a bottle or jar.
